(19) United States
(12) Patent Application Publication
(10) Pub. No.: US 2012/0210246 A1
(43) Pub. Date: Aug. 16, 2012

(54) Method, apparatus, system and computer program product for media management

(76) Inventors: Lars Byléhn, Chavannes-de-Bogis (CH); Mårten Ohlin, Bjarred (SE)

(21) Appl. No.: 13/354,805

(22) Filed: Jan. 20, 2012

Related U.S. Application Data
(60) Provisional application No. 61/434,852, filed on Jan. 21, 2011.

(51) Int. Cl. G06F 3/01; G06F 15/16

(52) U.S. Cl. 715/748

(57) ABSTRACT

A method for media management, said method comprising the steps of:
providing a link (112) for user accessible media content stored in a data base (101) in a data communications network such as the Internet, (step 201);
providing a set of user selectable file specific features (114) including browsing, distributing and down-loading media content; (step 203);
detecting a user request, (step 205);
transforming the user request into a corresponding selected feature, (step 206);
   wherein computer code(s) is embedded into each link (112) for providing the file specific features (114).

### RELATED APPLICATIONS

This application claims priority of U.S. Provisional Application No. 61/434,852, filed on Jan. 21, 2011, which is hereby incorporated by reference.

### TECHNICAL FIELD

The present invention relates to a method, apparatus, system and computer program product for media management

### BACKGROUND

Providers of media content, such as music, videos, audio books, and other content to be perceived by a user require efficient means for distributing the media content. Sometimes the providers also lose money due to theft; more specifically due to bootleg or other illegal copies of the media content being distributed.

A goal for a media content provider is to distribute the media content in as inexpensive way as possible.

Typically, another goal of a media content provider is to allow authorized users access the media content in the amount they paid for, without undue hassle to those authorized purchasers.

### SUMMARY OF THE INVENTION

According to an aspect, the present invention describes a method, apparatus, system for distributing media content to a user in an efficient and inexpensive way.

According to an aspect, the present invention describes a method, apparatus and system for distributing media content to a user to allow authorized users access the media content in the amount they paid for, without undue hassle to those authorized purchasers.

According to an embodiment of the present invention, there is provided a method for media management, comprising the steps of:
providing a link for user accessible media content stored in a data base in a data communications network such as the Internet;
providing a set of user selectable file specific features including browsing, distributing and down-loading media content;
detecting a user request;
transforming the user request into a corresponding selected feature;
   wherein computer code(s) is embedded into each link for providing the file specific features.

Typically, a graphical user interface such as a window for controlling downloading of media content is provided.

Typically, a set of user selectable file specific features including redirecting media content, is provided instead of down-loading.

Typically, a media store is created such that it represents a user specific web page having links for user accessible media content stored in a data base.

Typically, one or more of the user selectable file specific features can be switched off.

Typically, data is handled as code for further transport to other systems using the same computer code.

There is also provided a system and an apparatus for implementing the method.

There is also provided a computer program product comprising in a computer executable code means, when loaded into the computer to perform the method or implement the apparatus.

### BRIEF DESCRIPTION OF THE DRAWINGS

The features and advantages of the present invention as described and additional ones will become further apparent from the following detailed description and the accompanying drawings, of which:

FIG. 1 illustrates a system for providing a media store according to an embodiment of the present invention; and

FIG. 2 illustrates a flow chart of a method for providing a media store according to an embodiment of the present invention.

### DETAILED DESCRIPTION OF THE INVENTION

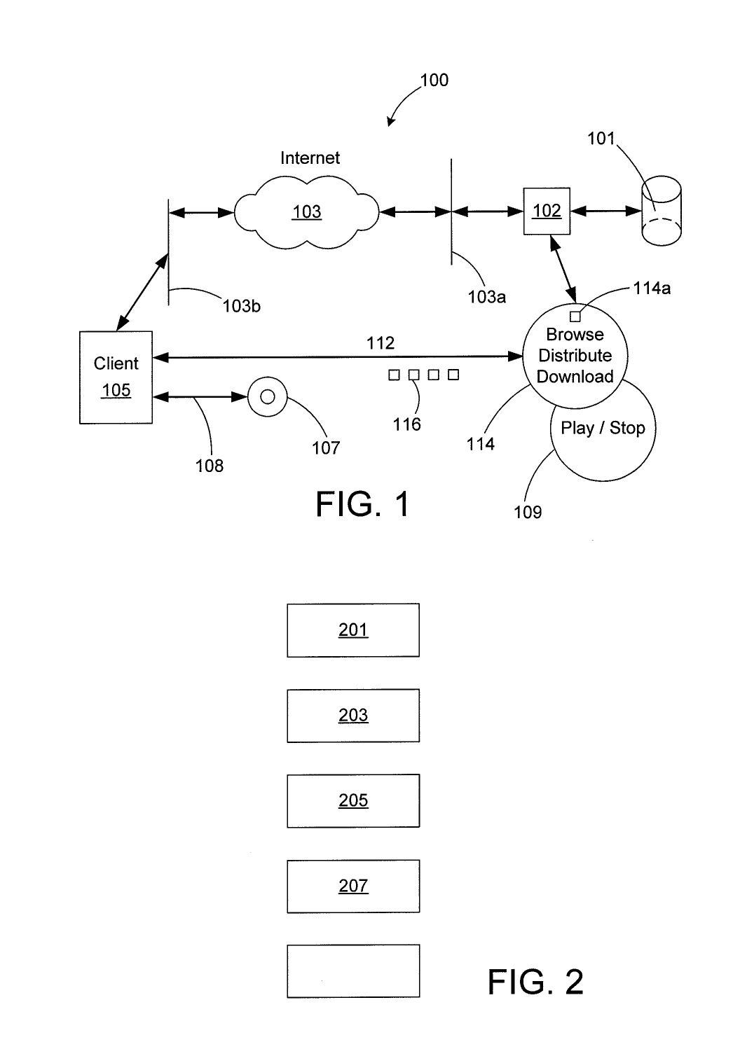

Now is first referred to FIG. 1 illustrating a system 100 for media management, in particular for providing a media store, according to an embodiment of the present invention. Herein, the term “media store” is defined as a user specific web page having links for user accessible media content stored in a data base.

The system 100 comprises a data base 101 having media content such as music, videos, audio books and other content to be perceived by a user (not shown), typically, to be freely downloaded. The data base 101 is managed by a server 102, typically a web-server, connected to a data communications network 103, herein the Internet. The server 102 has a first communications interface 103a connected to a first side of the network 103. On a second side of the network 103 there is provided a client 105 connected to a second communications interface 103b of the intervening network 103, located between the first and second interfaces 103a, 103b. The client 105 herein being an external computer such as a lap-lop computer, PC, or other computerized portable communication device such as a smart phone provided for the Internet, is arranged to be connected to the server 102 through the communication interfaces 103a, 103b and via the intervening network 103. In this way, the client 105 could exchange data with the data base 101, such that the data base 101 is accessible, also for perceiving and/or handling media content, to the client 105.

Now is also referred to FIG. 2 illustrating a flow chart of an embodiment of the method according to the invention.

The server 102 is arranged to provide a link 112 for user accessible media content stored in the data base 101, step 201, and to provide a set of user selectable file specific features 114 including browsing, distributing and down-loading media content, step 203. The link 112 can alternatively be provided by another remote computer means or server than by the server 102 shown in the figure; however, this is not described since it is obvious for a person skilled in the art of computer science to design based on the embodiment shown and described. The link 112 per se provides file specific features 114 for displaying the file(s) available, distribution alternatives and down-loading the file(s) for a user request such as a purchase, step 205.

Computer code(s) 116 for the file specific features 114 is embedded into each link 112 for providing the file specific features 114. This computer code 116 for the file specific features 114 is embedded into the link 112 and can be redistributed to another location such as to another server, or to the same server 102, but accessible to other users, than only to the user distributing the file specific features 114. The computer code 116 can also be copied and inserted to another location such as another web-page according to the user preference, typically according to the users preference distributing the file specific features and depending on content provider restrictions. Some content providers may not allow all kinds of distribution of the file specific features 114.

Each feature (browsing, distribution and down-loading) will be described as follows in more detail.

Browsing: When the user finds a link 112, the link 112 provides, step 201, 203 built-in features which are graphically displayed to the user, for instance a trailer of a movie, so that the user can see what he/she could purchase, or a media player including at least a play/stop feature such that a music-sample can be played. Typically music files can be listened to in advance before being purchased by means of the play/stop feature, but also other conventional features of a media player are possible even if they are not illustrated or described herein. If links for other file types are provided, they can be designed individually according to preference. For instance, a movie file can show a trailer instead of part of the real movie. For instance, a text file can show a window of a few pages that can be read without the user having to start an external program, open further windows in the browser or change web-page. The present invention is designed to provide a user to make a quick and easy decision to buy the media content, such as the music file or to continue browse to find another file, by detecting a user request, step 205 and transforming the user request into a corresponding selected feature, step 205.

All features are created graphically such that it is easy for the user to understand the features available. According to an embodiment of the invention, a graphical user interface 109 such as a window is provided to the client 105, step 207. In alternative embodiments of the present invention it is possible to hide one or more of the features available, or to provide different features to different users. This might be important if an artist or advertiser require that certain restrictions may apply. For instance, an advertiser can have exclusive rights to be the sole provider of a certain music piece during a certain period of time, such that the sharing feature is not available. If desired, the down-loading feature can be swapped to a redirect feature for promoting new web pages from which the music piece can be down-loaded. Then it is possible to share the link, but from an external web-page to which the link has been redirected.

### Distribution:

The link 112 comprises a file sharing and/or swapping feature providing a user to share and transfer a copy of the link 112 and the built-in features 114 according to user preference or need. Copies can be transferred to blogs, social networks, private or commercial web sites. The transfer is provided by means of a computer code 116 which is pasted. The computer code 116 is compatible with all environments. There can also be provided sharing features which are specifically designed such as social communities having unique requirements. In those cases there is provided a special feature for this, typically in the form of a key.

Users can also create their own web pages having one or more link(s) for creating a hybrid between a fan web page and a file store. All blog tools up to now can handle the code without difficulties. This provides great possibilities to share media content, but also to provide new web pages on the Internet. Today, music is not accessible to a great extent being available on a large number of web sites but only on a few. The invention solves this problem and fulfills the long-felt need to overcome this.

### Down-Loading, Purchase:

In each link 112, there is a computer code embedded for a transaction to be performed. When the downloading begins, a window is opened, within the web-page present. The window is provided to support management of down-loading including payment if required. Typically, payment can be made by means of paying by receiving advertisements, such as videos and offers, which in their turn pays the artist and the content provider, and/or the system provider. Following payment and down-loading, the user can continue operating the present web-page. It is also possible to provide payment by means of any conventional method. The code for handling the media content including payment is embedded into the link and can be transferred, typically copied to any other location, there providing a media store. In this way, the user per se transfers the media store without any further marketing being required.

According to an embodiment of the present invention, there is provided an apparatus 106 for media management. The apparatus 106 comprises:
means 112a for providing a link 112 for user accessible media content stored in a data base 101 in a data communications network such as the Internet;
means 114a for providing a set of user selectable file specific features 114 including browsing, distributing and down-loading media content;
means 205a for detecting a user request;
means 206a for transforming the user request into a corresponding selected feature;
   wherein computer code(s) is embedded into each link 112 for providing the file specific features 114.

According to an embodiment of the invention, there is provided a computer program product having computer code means, when executed in a computer being arranged to perform the method.

In the embodiment in FIG. 1, the client 105 includes a personal computer connected to a media player 107, for example, a portable, battery-operated device. In one embodiment, the media player 107 is an MP3 player.

The personal computer 105 includes an apparatus for managing media content, in the following called a media manager 106. The media manager 106 enables a user of the personal computer 105 to directly manage media content stored on the server 101, and to indirectly manage media content stored on the media player 107 as well as on another web-server (not shown) on which a media store is created by means of media content, all or partly, being transferred from the server 102. A peripheral cable 108 connects the media player 107 to the personal computer 105. Typically, the peripheral cable 108 couples together data ports provided on the media player 107 and the personal computer 105. The peripheral cable 108 acts as a data connection. Media content including control information can also be transferred from the media player 107 to the personal computer 105 over the peripheral cable 108, and vice versa. For example, the media manager 106 facilitates a user with browsing, adding, deleting, organizing, and other operations with respect to media content (e.g., numerous media items) on the personal computer 105. Additionally, for example, the media manager 106 also facilitates a user with adding and removing media content on the media player 102. In other words, although the media manager 106 resides on the personal computer 105, at least certain management action taken with respect to the media manager 106 can cause the media content at the media player 107 to be similarly managed.

In one embodiment, the media player is a portable computing device dedicated to processing media such as audio, video or images. For example, the media player 107 can be a music player (e.g. MP3 player), a game player, a video player, a video recorder, a camera, an image viewer and the like.

For purposes of this embodiment, the description will in the following refer to music files only, however it should be understood that the system can use any media content. Moreover, the embodiments described herein include a number of different features, which will be separately described, however it should be understood that any of these features can be used in any combination.

Embodiments of the invention have been described above with reference to FIGS. 1-2. However, those skilled in the art will readily appreciate that the detailed description given herein with respect to these figures is for explanatory purposes as the invention extends beyond these limited embodiments.

The foregoing detailed description is intended to illustrate and provide easier understanding of the invention, and should not be construed as limitations. Alternative embodiments will become apparent to those skilled in the art without departing from the spirit and scope of the present invention.

1. A method for media management, said method comprising the steps of:
providing a link for user accessible media content stored in a data base in a data communications network such as the Internet;
providing a set of user selectable file specific features including browsing, distributing and down-loading media content;
detecting a user request;
transforming the user request into a corresponding selected feature;
wherein computer code(s) is embedded into each link for providing the file specific features.

2. The method according to claim 1, further comprising the step of locally providing a graphical user interface such as a window for controlling downloading of media content.

3. The method according to claim 1, comprising providing a set of user selectable file specific features including redirecting media content, instead of down-loading.

4. The method according to claim 2, wherein the media store is created such that it represents a user specific web page having links for user accessible media content stored in a data base.

5. The method according to claim 4, wherein one or more of the user selectable file specific features can be switched off.

6. The method according to claim 2, wherein data is handled as code for further transport to other systems, for instance copying, using the same computer code.

7. Apparatus for media management, said apparatus comprising:
means for providing a link for user accessible media content stored in a data base in a data communications network such as the Internet;
means for providing a set of user selectable file specific features including browsing, distributing and down-loading media content;
means for detecting a user request;
means for transforming the user request into a corresponding selected feature;
wherein computer code(s) is embedded into each link for providing the file specific features.

8. A system for media management, comprising
a data base having media content and
a server connected to the data base for handling the data base, the sever connected via an intervening network to a client comprising an apparatus for media management, said apparatus comprising:
means for providing a link for user accessible media content stored in a data base in a data communications network such as the Internet;
means for providing a set of user selectable file specific features including browsing, distributing and down-loading media content;
means for detecting a user request;
means for transforming the user request into a corresponding selected feature;
wherein computer code(s) is embedded into each link for providing the file specific features.

9. A computer program product having computer code means, when executed in a computer being arranged to perform the method according to claim 1.
